(19) United States
(12) Patent Application Publication
(10) Pub. No.: US 2007/0119839 A1
(43) Pub. Date: May 31, 2007

(54) HEAT DISSIPATION PLATFORM

(75) Inventors: Todd E. Kooken, University Hts., OH (US); Theresa Chih-Lei Miao Spear, Highland Hts., OH (US)

Correspondence Address: FAY SHARPE LLP, 1100 SUPERIOR AVENUE, SEVENTH FLOOR, CLEVELAND, OH, 44114, US

(73) Assignee: LINCOLN GLOBAL, INC., City of Industry, CA (US)

(21) Appl. No.: 11/627,935

(22) Filed: Jan. 26, 2007

Related U.S. Application Data
(63) Continuation of application No. 10/617,121, filed on Jul. 11, 2003.

(51) Int. Cl. B23K 9/10

(52) U.S. Cl. 219/130.1

(57) ABSTRACT

A heat dissipation platform for output switches of an inverter power source of an electric arc welder where the platform comprises a conductive plate with first and second parallel surfaces and a plurality of parallel heat pipes embedded between the surfaces and extending in a given direction and the switches are mounted on the first surface and are closely spaced from each other in the given direction of the heat pipes.

This application is a continuation of U.S. patent application Ser. No. 10/617,121 filed on Jul. 11, 2003 and entitled “HEAT DISSIPATION PLATFORM,” the entirety of which is incorporated herein by reference.

### BACKGROUND

The present invention relates to the art of electric arc welding and more particularly to a heat dissipating platform for the output switches of the power source used in an electric arc welder.

### INCORPORATION BY REFERENCE

An electric arc welder often employs an inverter having high speed switches to create an AC output. Output switches driven by the rectified output of an inverter create either an AC or a DC welding operation. A power source with such output switches is disclosed in Stava U.S. Pat. No. 6,489,592, incorporated by reference herein as background information. The output switches from the inverter can be operated in an AC mode or a DC mode for either a positive or a negative welding operation. This technology is background to the present invention, which relates to a heat dissipation platform to balance the heat of the output switches. This novel platform employs heat pipes as manufactured by Thermacore, Inc. of Lancaster, Pa. Such a device is shown in Rosenfield U.S. Pat. No. 5,076,352 and in an Internet publication entitled Heat Pipe Design. Both of these publications are incorporated by reference herein to show the structure of a heat pipe of the type used in practicing the present invention.

### BACKGROUND OF INVENTION

In an electric arc welder having an inverter power source and output switches to convert between AC and DC welding as shown in Stava U.S. Pat. No. 6,489,592, the output switches and parallel snubbers create a substantial amount of heat. In the past, these switches were mounted on a heat dissipating platform with a heat sink having fins through which air is circulated. With the advent of the AC output switches and the use of these switches as a positive or negative chopper, previous heat platforms have not been capable of balancing the heat generated by the spaced output switches. It is advisable that the switches be maintained at the same temperature for consistent operation. In opposite polarity operation the duty cycle of the switches can vary between 0% and 100%. Thus, it is difficult to balance the heat between the two switches. The platform heretofore used did not solve this problem and did not balance the heat at the switches especially in DC operation. Such previous heat dissipation platform has not been successful and resulted in lower efficiency of the output switches.

### THE INVENTION

The present invention relates to a novel heat dissipation platform for the output switches of an inverter power source used in an electric arc welder. This platform comprises a conductive plate with the first and second parallel surfaces. The output switches are mounted onto the first surface and are closely spaced from each other in a given direction. The object is to balance the heat between these two output switches, especially when they are operated in the DC mode. In accordance with the invention, a plurality of parallel heat pipes are embedded between the surface of the conductive plate and extend in the same given direction as the spaced direction of the output switches. In this manner, the parallel heat pipes equalize temperature between the two switches, even though one of the switches is operated at a substantially higher power than the other switch. In accordance with another aspect of the invention, a heat sink of high heat conductivity material with a thin mounting plate is located on the second surface of the conductive plate and includes integral, parallel fins protruding from the mounting plate and extending in the same direction as the spacing between the output switches. This platform construction has been successful in equalizing the temperature between the output switches, even when the switches are operated at substantially different power levels. When one or the other of the output switches is used to create a DC output welding mode, the platform quickly dissipates heat and still maintains a temperature balance between the two switches.

The primary object of the present invention is the provision of a heat dissipation platform that can equalize the temperature between two output switches in an electric arc welder driven by an inverter power source.

Still a further object of the present invention is the provision of a heat dissipation platform, as defined above, which platform includes a conductive plate having a plurality of embedded heat pipes.

These and other objects and advantages will become apparent from the following description taken together with the accompanying drawings.

### BRIEF DESCRIPTION OF DRAWINGS

FIG. 1 is a wiring diagram showing the output switches in an electric arc welder as generally described in Stave U.S. Pat. No. 6,489,592;

FIG. 2 is a schematic layout drawing showing two switches as illustrated in FIG. 1 with two heat dissipation platforms of the type used in the prior art;

FIG. 3 is a side partially cross-sectioned view of the preferred embodiment of the present invention;

FIG. 4 is a cross-sectional view taken generally along line 4-4 of FIG. 3; and,

FIG. 5 is a view similar to FIG. 4 showing a further modification wherein a fan is used to force air toward the heat dissipation platform of the present invention.

### PREFERRED EMBODIMENT

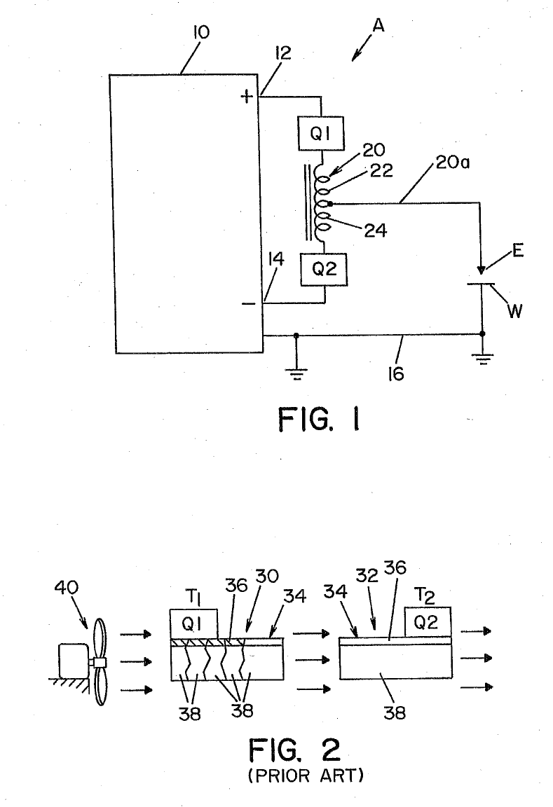

An electric arc welder, as shown in Stava U.S. Pat. No. 6,489,592, is represented as welder A in FIG. 1 wherein an electrode E and workpiece W represent the output of a welder. A power source, in the form of an inverter 10, provides a positive voltage at terminal 12 and a negative voltage at terminal 14 are connected to opposite ends of center tapped choke 20. The center tap 20a is connected to electrode E. The electrode and workpiece W with ground 16 form the welding circuit. In accordance with the Stava disclosure, choke 20 includes sections 22, 24 so that output switches Q1 and Q2 can be operated in unison for AC welding, or separately for DC welding. Each of these output switches includes associated components, such as snubbers, and are in the form of a substantially large area package. As shown in FIG. 2, output switches Q1, Q2, are normally mounted on separate heat sinks 30, 32 each of which has a platform 34 in the form of a thin conductive plate 36 having depending, laterally extending fins 38, best shown by cutaway of platform 30. The fins extend in the direction between switches Q1, Q2 to balance the temperature between the two switches, especially during AC welding. To enhance the cooling effect of platforms 30, 32 it is common to use a fan 40 blowing through fins 38 in an effort to balance the temperature T₁ at switch Q1 on heat sink 30 with T₂ at switch Q2 on heat sink 32. Since the heat generated at the output switches varies according to the polarity and duty cycles and the associated components, platforms 30, 32 do not effectively balance temperatures T₁ and T₂.

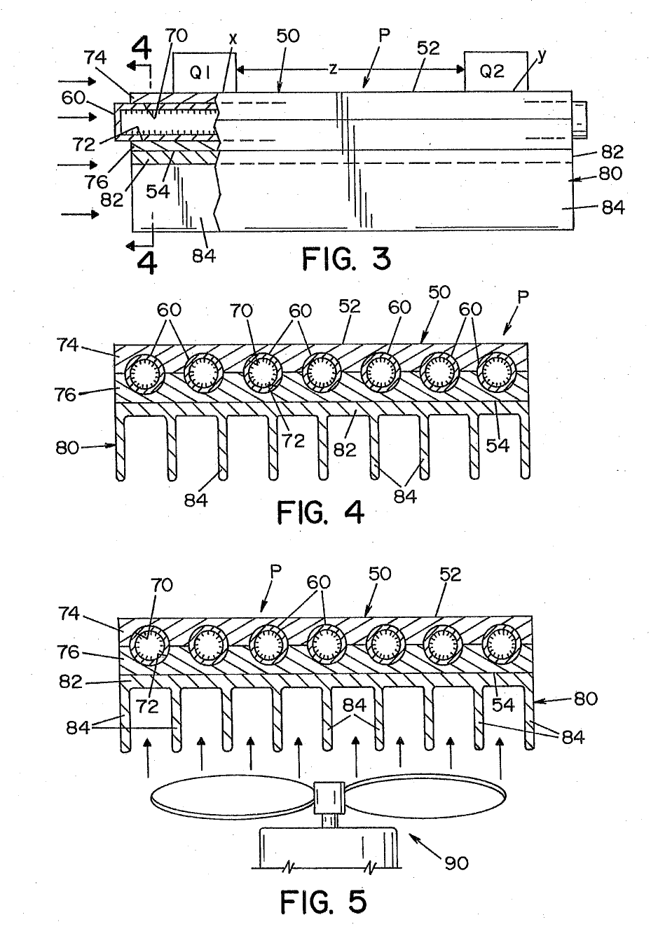

Novel platform P is shown in FIGS. 3 and 4. The platform does balance the temperatures of the output switches Q1, Q2 located at locations x and y, respectively. These two switches are essentially as close together as the package containing the switches will allow. This results in a spacing z between the switches Q1, Q2, which distance is the direction of spacing between the switches. Platform P is provided with a unique conductive plate 50 having an upper surface 52 on which the switches are mounted at locations x, y and a lower parallel surface 54. Between these surfaces there are a plurality of elongated, embedded heat pipes 60 mounted in semi-cylindrical recesses 70, 72 in portions 74, 76 of plate 50. The recesses can be in the upper surface of plate 50. The heat pipes are standard products and are sold by Thermacore, Inc. of Lancaster, Pa. They include internal wicking in a vacuum containing a slight amount of fluid. Such heat pipes equalize the temperature between locations x, y of surface 52. In another embodiment of the invention, plate 50 is a single piece and the holes for the heat pipes are drilled through the plate. In other embodiments, the heat pipes are flat or rectangular in cross-section. Heat pipes 60 extend in direction z to equalize the temperature between locations x, y. In accordance with an aspect of the invention, lower surface 54 of plate 50 is provided with a standard heat sink 80 comprising thin mounting plate 82 and downwardly extending, parallel spaced fins 84 extending in the direction z. It has been found that this novel platform equalizes the temperature of switches Q1, Q2 especially in unbalanced AC operation at widely varying duty cycles. As shown in FIG. 5, fan 90 is used to blow air through fins 84 in a direction perpendicular to plate 50. In practice, two fans 90 are used and are positioned below both location x and location y in FIG. 3. In this use of the present invention, heat sink 80 is sometimes divided into two heat sinks one at location x and the other at location y.

Various modifications and arrangements of the components constituting platform P can be made in accordance with the invention as defined in the following claims

1. An electric arc welder comprising:
an inverter having a positive terminal and a negative terminal;
a choke electrically connected to the inverter;
a first output switch electrically connected to the choke and the positive terminal of the inverter for operation in a positive DC mode or in an AC mode;
a second output switch electrically connected to the choke and the negative terminal of the inverter for operation in a negative DC mode or in an AC mode;
a heat conductive platform, the switches being mounted on a first surface of the heat conductive platform and spaced from one another in a first direction; and
a heat pipe disposed adjacent a second surface of the heat conductive platform and in thermal communication with the platform, the heat pipe extending in the first direction for equalizing the temperature between the output switches even when the switches are operated at substantially different power levels.

2. The welder of claim 1, further comprising a fan configured to blow air towards and generally perpendicular to the second surface.

3. The welder of claim 2, wherein the first output switch mounts to the platform at a first location and the second output switch mounts to the platform at a second location, the fan including a first fan configured to blow air towards the first location and a second fan configured to blow air towards the second location.

4. The welder of claim 1, wherein the choke is configured for operating the switches in unison for an AC welding operation or for operating the switches separately for a DC welding operation.

5. The welder of claim 4, wherein the choke is configured for operating the switches in unison at varying duty cycles for an AC welding operation.

6. The welder of claim 5, wherein the duty cycle of each switch can vary between 0% and 100% in AC operation.

7. The welder of claim 1, further comprising a heat sink of high heat conductivity material having a thin mounting plate in contact with the second surface and integral, parallel fins protruding from the mounting plate in a direction away from the second surface and extending in the first direction.

8. The welder of claim 1, wherein the heat pipe is mounted in a groove in the first surface.

9. An electric arc welder comprising:
a negative output switch;
a positive output switch;
an inverter providing a positive voltage to the positive output switch and a negative voltage to the negative output switch;
a choke in electrical communication with the switches for operating the switches in unison for an AC welding operation or for operating the switches separately for a DC welding operation;
a heat conductive platform, the switches being mounted on first surface of the heat conductive platform and being spaced from one another in a given direction;
a heat pipe disposed adjacent a second surface of the heat conductive platform and in thermal communication with the platform for equalizing the temperature of the switches.

10. The welder of claim 9, wherein the choke is configured to operate the switches in unbalanced AC operation at varying duty cycles.

11. The welder of claim 10, wherein the duty cycle of each switch can vary between 0% and 100% in AC operation.

12. The welder of claim 10, further comprising a fan configured to blow air towards the heat conductive platform.

13. The welder of claim 12, wherein the fan is configured to blow air towards and generally perpendicular to the second surface.

14. The welder of claim 12, wherein the first output switch mounts to the platform at a first location and the second output switch mounts to the platform at a second location, the fan including a first fan configured to blow air towards the first location and a second fan configured to blow air towards the second location.

15. The welder of claim 10, further comprising a heat sink of high heat conductivity material having a thin mounting plate in contact with the second surface and integral, parallel fins protruding from the mounting plate in a direction away from the second surface and extending in the given direction.

16. The welder of claim 10, wherein the heat pipe is mounted in a groove in the first surface.

17. A welder comprising an inverter power source including first and second output switches capable of being operated in unison for AC welding and separately for DC welding, the output switches being mounted on a heat dissipation platform including means for equalizing temperature between the first output switch and the second output switch.

18. The welder of claim 17, wherein the means for equalizing temperature comprises a plurality of heat pipes in thermal communication with the heat dissipation platform.
